(19) United States
(12) Patent Application Publication
(10) Pub. No.: US 2022/0111235 A1
(43) Pub. Date: Apr. 14, 2022

(54) Disposable Masks with Improved Life Span

(71) Applicant: AOK Tooling Ltd., Kowloon (HK)

(72) Inventor: Mei-Sheng Teng, Kowloon (HK)

(21) Appl. No.: 17/498,223

(22) Filed: Oct. 11, 2021

Related U.S. Application Data
(60) Provisional application No. 63/090,122, filed on Oct. 9, 2020.

(51) Int. Cl. A62B 23/02; A41D 13/11; B01D 46/00

(52) U.S. Cl. CPC A62B 23/025; A41D 13/1161; A41D 13/113; A41D 2500/30; A41D 2400/52; B01D 46/0032

(57) ABSTRACT

The present invention provides a protective face mask having a two layer structure configured to have increased efficiency rate and longer filtration hours, while reducing resistance. In one embodiment, the protective mask of the present invention comprises layers treated with electret masterbatch.

### CROSS-REFERENCE TO RELATED APPLICATIONS

The present application is entitled to priority to U.S. Provisional Application No. 63/090,122, filed Oct. 9, 2020, which is incorporated by reference herein in its entirety.

### BACKGROUND OF THE INVENTION

The disposable protective masks currently on the market are mainly composed of a three-layer structure having two layers of non-woven fabric with a melt-blown layer sandwiched between the non-woven fabric layers. The non-woven fabric generally has little filtration efficiency, it is the melt-blown material that has filtration efficiency. The filtration efficiency of the melt-blown cloth is created by an electret vehicle to form an electrostatic charge allowing for the adsorption of particles to deliver the filtration efficiency. Because the melt-blown material is designed to filter particles as small as 0.001 mm, the fibers are relatively fine and dense, thus creating significant resistance. When the resistance of the mask is greater than 112 pa, carbon dioxide is trapped in the respiratory tract and upper cavity, and inside the mask during breathing. This build-up of carbon dioxide causes discomfort to the wearer due to hypoxia. This discomfort also creates two risks to the wearer: 1.) Taking off the mask for ventilation leaves the wearer at risk of infection from airborne particles; 2.) The inhalation of too much carbon dioxide may also cause carbon dioxide poisoning.

In order to improve the filtration efficiency of the mask, the fibers in the melt-blown material are relatively fine and dense, creating high resistance. Additionally, as the humidity in the air enters the fine and dense fibers of the melt-blown material, the melt-blown fibers twist into bundles and expand, lessening the ventilation gaps between the fibers. The combination of these factors increases the breathing resistance of the mask, causing the resistance to exceed 112 Pa. The mask cannot be continuously used without causing risks to the wearer. Moreover, the fibers are twisted into bundles and swell due to the moisture in the air; therefore, after 2-4 hours of normal wear, the rate of failure increases as the filtration efficiency drops below 95% while the resistance will increase to 200 Pa-250 Pa. This has been repeatedly confirmed in experimental settings and poses a hidden danger for doctors, nurses and other users of masks.

For the disposable protective masks currently on the market, if the filtration efficiency is to be increased, the thickness of the melt-blown material will inevitably have to be increased, leading to a higher resistance. If the resistance is to remain low, then the filtration efficiency must be sacrificed. It is difficult to achieve high filtration with low resistance with the current structure of the disposable protective face masks. Research and regulations on disposable protective masks is limited, leading to specifications and regulations only considering the initial functions of masks, while failing to identify the risks of mask failure during use, thus posing a potential safety hazard for users in medium and high risk areas.

Thus, there is a need in the art for the development of a disposable protective mask that can achieve higher filtration efficiency with low resistance over a longer period of time, on the scale of days of working hours. The present invention meets this need.

### SUMMARY OF THE INVENTION

In one aspect, the present invention relates to a protective face mask comprising: a body having a two-layer filtration system comprising an outer layer and an inner layer, each layer comprising an electret masterbatch material having an electrostatic charge; and an attachment means, wherein the attachment means are configured to hold the body over a mouth and nose of a wearer.

In one embodiment, the outer layer comprises a filtration efficiency of between about 50% and 70% and a ventilation resistance of between about 20-40 Pa. In one embodiment, the inner layer comprises a filtration efficiency of between about 80% and 90% and a ventilation resistance of between about 35-55 Pa. In one embodiment, the outer layer is configured to filter particles that are above PM 3.0 in size. In one embodiment, the inner layer is configured to filter particles less than PM 2.5 in size. In one embodiment, the two-layer filtration system has a combined filtration efficiency of at least 96%. In one embodiment, the face mask can be effectively used for at least 24 hours. In one embodiment, the outer layer and the inner layer each comprises a filtration efficiency and a ventilation resistance that are each adjustable such that different permutations and combinations are produced targeting different industries and users. In one embodiment, the electret masterbatch comprises a water cooled process configured to achieve a high volume electrostatic charge. In one embodiment, the electret masterbatch is a polypropylene masterbatch. In one embodiment, the outer layer comprises between about 60% and 85% coarse fibers and between about 15% and 40% fine fibers. In one embodiment, the inner layer comprises about 30% coarse fibers and about 70% fine fibers. In one embodiment, the inner layer comprises a melt-blown non-woven material. In one embodiment, a density of the inner layer is greater than a density of the outer layer.

In one embodiment, the face mask is configured to retain a low differential pressure of less than 4.0 mmH₂O/cm². In one embodiment, the attachment means are in the form of ear loops, configured to loop behind the wearer's ears. In one embodiment, the attachment means are in the form of a head strap, configured to wrap around the wearer's head. In one embodiment, the face mask further comprises a nose clip positioned on the body and is configured to bend the protective mask over the wearer's nose to create a seal within a nasal area.

In one aspect, the present invention relates to a method of electrostatic treatment using cooled water in a non-woven material, comprising the steps of: providing a base non-woven material; spunlacing the non-woven material, such that an electrostatic charge is generated on the non-woven material through friction between cooled water and the non-woven material; and drying the non-woven material. In one embodiment, the drying step is performed using a blower vacuum. In one embodiment, the drying step is performed using an oven. In one embodiment, the oven is set at a temperature between about 60° C. and 80° C.

### BRIEF DESCRIPTION OF THE DRAWINGS

The following detailed description of exemplary embodiments of the invention will be better understood when read in conjunction with the appended drawings. It should be understood, however, that the invention is not limited to the precise arrangements and instrumentalities of the embodiments shown in the drawings.

FIG. 1 depicts a schematic cross-sectional view of an exemplary mask.

FIG. 2 depicts 50× magnified images of fine fibers (left) and coarse fibers (right).

FIG. 3 shows the results of a NaCl filtration efficiency test. The left image is a mask prior to the test. The right image depicts prototype masks after a test, demonstrating the filtration efficiency of the masks.

### DETAILED DESCRIPTION

It is to be understood that the descriptions of the present invention have been simplified to illustrate elements that are relevant for a clear understanding of the present invention, while eliminating, for the purpose of clarity many other elements found in the field of respirators and face masks. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined elsewhere, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range.

### Protective Mask

The present invention provides protective masks configured to provide double filtration in order to achieve high filtration with low resistance. The main materials of the mask are non-woven fabric and melt-blown filter cloth. The patent mask uses the two-layer filtering principle to share the burden of filtration of the mask. The outer non-woven fabric serves as the first filter. Due to the outer non-woven fabric's relatively large air gap, larger particles are filtered first. And because the air gap is relatively large, smaller particles can pass through, while the melt-blown cloth serves as the second filter. In one embodiment, the protective masks of the present invention can be used for an extended period of time due to the double filtration technique. In one embodiment, the low resistance reduces the retention of CO₂ in the masks and reduces the discomfort caused by long term wear. In one embodiment, the protective mask of present invention can remain effective with high filtration efficiency and low resistance for more than 8 hours or more than 24 hours, wherein the life-span of existing disposable protective masks is approximately 2-4 hours, which cannot meet the needs of doctors, workers or other users who depend on the effectiveness of the masks. In one embodiment, the protective masks of present invention experience a negligible drop in filtration efficiency after a high temperature and high humidity aging test, thus demonstrating an increase in the service life and shelf life of the masks.

The present invention improves the surface treatment process of non-woven fabric and melt-blown non-woven material by adding water resistant masterbatch to both materials, thus forming the surface area of electrostatic absorption. This allows for higher filtration efficiency while effectively reduces filtration resistance. While using the mask, the outer layer non-woven fabric has relatively thick fibers with relatively larger air gaps. The static electricity of the non-woven fabric is used to first to filter large particles, while small particles can pass through the relatively large gaps. With the two layers of low-efficiency and low-resistance non-woven fabric and melt-blown non-woven material, when particles in the air enter the mask, the non-woven fabric filters the large particles in the air first, and the remaining particles pass through and are filtered by the second melt-blown non-woven material layer. This allows for a two layer filtration system with non-woven fabric serving as the first layer and melt-blown non-woven material serving as the second layer of filtration. The resulting mask can achieve low resistance and high filtration efficiency, with a combined filtration efficiency reaching more than 96%. At the same time, the two-layer filtration principle can extend the use time of masks to more than 8-9 hours, which can meet the work and daily needs of doctors, workers or other users. Due to the two-layer filtration, the two-layer of filter material can share the burden of filtration in order to achieve high efficiency. At the same time, both layers of filtration materials are low efficiency and low resistance, allowing the user to wear the mask for more than 9 hours without the fatigue caused by traditional high resistance masks.

In some embodiments, the fiber of the outer non-woven fabric resident has a filtration efficiency of about 50-70% or greater and a ventilation resistance of about 20-40 Pa and filters particles larger than PM3.0 in the air. Small particles that pass through the outer non-woven fabric layer are filtered through water electret melt-blown non-woven material layer. In some embodiments, the melt-blown non-woven material layer has a filtration efficiency of about 80-90% or greater and a ventilation resistance of about 35-55 Pa to remove small particles less than PM2.5, allowing the overall filtration efficiency to reach more than 96%. Additionally, by adjusting the filtration efficiency and ventilation resistance of the non-woven fabric and the melt-blown non-woven material, different permutations and combinations are possible to produce different filtration efficiency and ventilation resistance to target different industries and users.

The protective masks of the present invention comprise a body and attachment means. The body of the mask may be made of any material that substantially covers the mouth and nose of a wearer. The material forming the body of the mask may have a variety of shapes and configurations that allow it to conform to the wearer's face, such as a generally rectangular shape, a contoured shape, or a combination of shapes.

The body is held to a wearer's mouth and nose by an attachment means. In one embodiment, the attachment means may be in the form of ear loops configured to loop behind the wearer's ears to hold the body to the wearer's mouth and nose. In one embodiment, the attachment means may be in form of a head strap that is configured to wrap around the wearer's head to hold the body in position. In one embodiment, the attachment means may be attached to the body by any means known to one skilled in the art, including but not limited to heat pressing, stitches, adhesives, staples, and the like. In one embodiment, the attachment means may be made of elastic materials that stretch towards the sides of the wearer's face so as to provide the protective mask with greater comfort and a better fit against the wearer's face in use.

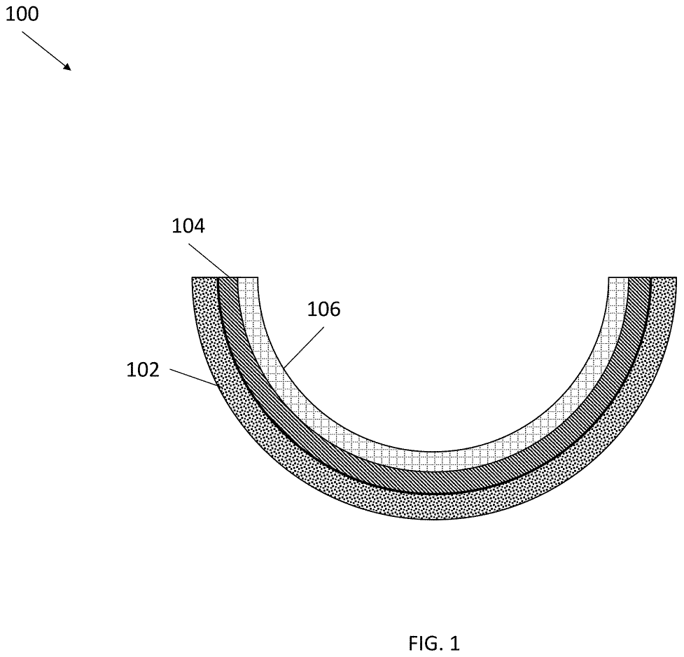

The body comprises at least an outer layer and an inner layer. Referring now to FIG. 1, a schematic cross-sectional diagram of an exemplary mask 100 is depicted showing outer layer 102 and inner layer 104. In some embodiments, mask 100 can further comprise a padding layer 106 positioned on inner layer 104 on a side that is opposite to outer layer 102. Accordingly, mask 100 is configured to be worn such that outer layer 102 faces outwards while inner layer 104 faces towards a wearer. In embodiments comprising a padding layer 106, padding layer 106 touches the face of a wearer, and inner layer 104 is positioned between outer layer 102 and padding layer 106. In various embodiments, padding layer 106 can be made from a soft cloth or fabric, woven, or non-woven, which enhances comfort for a wearer.

In one embodiment, outer layer 102 may be made from a material including but not limited to a sheet, a cloth, a film, a web, a woven material, a non-woven material, and the like. In one embodiment, the nonwoven materials may include but are not limited to wet laid fibers, dry laid fibers, spun-laced fibers, spun-bond fibers, melt-blown fibers, spunbonded-melt blown-spunbonded (SMS) fibers, carded fibers, thermoplastic fibers, regenerated fibers, and bicomponent fibers such as sheath-core fibers. These nonwoven materials may include, but are not limited to, polyolefins such as polyethylene and polypropylene, polyesters such as PET, natural fibers, and cellulose materials. The nonwoven materials forming outer layer 102 of mask 100 may comprise mixtures of two or more of the foregoing fiber types.

In one embodiment, outer layer 102 is fabricated with an electret masterbatch, such that the resulting outer layer 102 comprises an electrostatic treatment configured to filter large particles in air (for example, PM 3.0 or particles 0.3 microns in width and higher). In one embodiment, the filtration efficiency of mask experiences no decrease or a negligible decrease after exposure to high temperature and high humidity, because the masterbatch electret's static electricity retention is more than 3 times that of the electric electret. In one embodiment, a wearer's exhalation pushes large particles off of an outward facing surface of outer layer 102, thus preventing resistance build-up. In one embodiment, outer layer 102 is configured to filter out larger particles representing between about 40% to 70% or greater of particles encountered by outer layer 102, thus reducing the filtration load of inner layer 104. In one embodiment, outer layer 102 reduces the likelihood of large particles directly entering inner layer 104 and thus greatly extends the life of protective mask 100.

In one embodiment, outer layer 102, inner layer 104, and padding layer 106 may each comprise fan fold pleats configured to allow the expandability of the area of mask coverage covering the mouth and nose of the wearer.

In one embodiment, outer layer 102, inner layer 104, and padding layer 106 may be attached together by different sealing methods depending on the selected materials. In one embodiment, the layers may be attached together by pressure and heat, such as by a heat weld. In one embodiment, the layers may be attached together by stitching. In one embodiment, the layers may be attached together by an adhesive.

In one embodiment, inner layer 104 may be made from a breathable filtering material including but not limited to a sheet, a cloth, a film, a web, a woven material, a non-woven material, and combinations thereof. In one embodiment, the nonwoven materials may include but are not limited to wet laid fibers, dry laid fibers, spun-laced fibers, spun-bond fibers, melt-blown fibers, spunbonded-melt blown-spunbonded (SMS) fibers, carded fibers, thermoplastic fibers, regenerated fibers, and bicomponent fibers such as sheath-core fibers. These nonwoven materials may include, but are not limited to, polyolefins such as polyethylene and polypropylene, polyesters such as PET, natural fibers, and cellulose materials. The nonwoven materials forming inner layer 104 of protective mask 100 may comprise mixtures of two or more of the foregoing fiber types.

In one embodiment, inner layer 104 may comprise one or more webs of fine inorganic fibers (such as fiberglass) or polymeric synthetic fibers. In one embodiment, inner layer 104 may comprise melt-blown non-woven materials. In one embodiment, the melt-blown non-woven materials adopt an electrostatic electret treatment process using an electret masterbatch to increase the electrostatic adsorption area of the melt blown cloth while reducing its ventilation resistance. This allows for an increase in the protective mask's filtration capacity, thus extending the life of the protective mask.

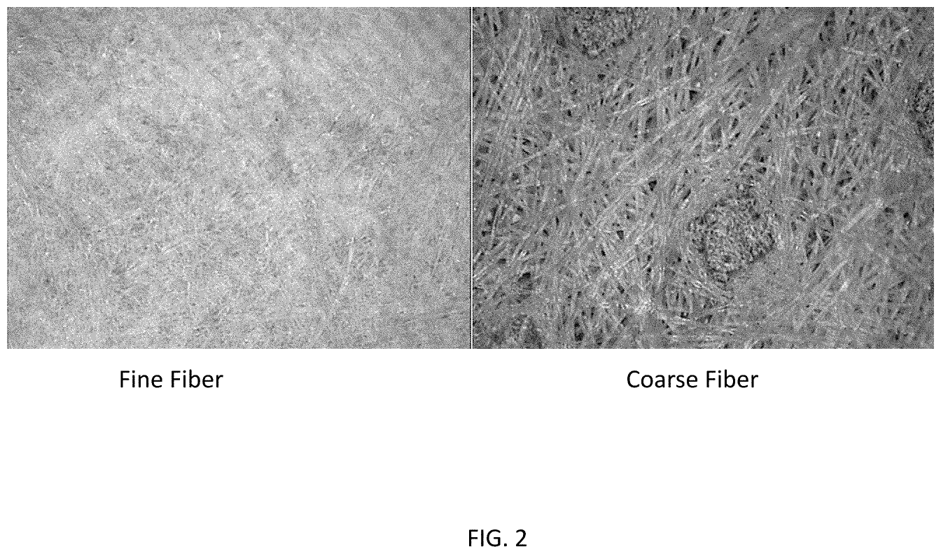

Using the two filter layers of low-efficiency and low-resistance non-woven fabric and melt-blown non-woven material, when particles in the air enter the mask, the non-woven fabric filters the large particles in the air first, and the remaining particles pass through and are filtered by the second melt-blown non-woven material layer. In this way, two-layer filtration is performed by non-woven fabric and melt-blown non-woven material, so that the mask can achieve the goal of low resistance and high efficiency, with the combined filtration efficiency reaching more than 96%. At the same time, the two-layer filtration principle can extend the use time of masks to more than 8-9 hours, which can meet the work and daily needs of doctors, workers or other users. Using different permutations and combinations can produce different filtration efficiency and ventilation resistance, as shown in FIG. 2.

In one embodiment, polypropylene masterbatch is added to outer layer 102, inner layer 104, or both. Outer layer 102 and inner layer 104, treated by the water electret electrostatic treatment, each adopts a mixed structure of coarse and fine fibers. In some embodiments, fine fibers have a diameter between about 1 μm and 100 μm. In some embodiments, coarse fibers have a diameter between about 50 μm and 500 μm. In some embodiments, the coarse fibers can account for between about 60% and 85% of outer layer 102. In some embodiments, the fine fibers can account for between about 40% and 15% of outer layer 102. In some embodiments, the coarse fibers can account for between about 20% and 40% of inner layer 104, such as about 30% of inner layer 104. In some embodiments, the fine fibers can account for between about 60% and 80% of inner layer 104, such as about 70% of inner layer 104. Outer layer 102 can thereby effectively filter out about 70% or greater of larger particles in the air (about PM 3.0 and above), and inner layer 104 can effectively filter out the remaining particles (about PM 2.5 and below).

In some embodiments, the electrostatic treatment of water electret to the layers of the mask is performed using the following process. In a first step, a base non-woven material of a layer of the mask is provided, wherein the base non-woven material comprises water electret masterbatch. The base non-woven material can be in the form of a roll of base non-woven material, wherein the roll of base non-woven material is loaded into an unwinding machine to be unwound into a single layer sheet. In a second step, the base non-woven material is fed into a flushing machine, wherein fan nozzles are used to spunlace the melt-blown non-woven material. Electrostatic charge is generated at this step using the friction between a jet of water and the melt-blown material during spunlacing. In some embodiments, the water is cooled water. The temperature of the cooled water can be between about 0° C. and 20° C., such as in the range of about 0° C. to 16° C., about 0° C. to 7° C., about 0° C. to 5° C., and about 0° C. to 3° C. In various embodiments, using cooled water to generate friction results in a much higher volume of electrostatic charge. In some embodiments, upon completion of the spunlace electret, the melt-blown material is dried, such as with a blower vacuum. In a final step, the base non-woven material is fed through an oven for further drying, such as at a temperature between about 60° C. and 80° C. In various embodiments, the speed of feeding into the oven can be adjusted to account for the amount of residual moisture left from the prior drying step. The base non-woven material can be subjected to further processing, such as by feeding into a fabric slitter, wherein the winding speed of the slitter can be linked and automatically adjusted based on the overall speed of base non-woven material feeding. In some embodiments, the base non-woven material can be held in an air-conditioned room for about 12 hours to complete a final drying step prior to packing.

In one embodiment, the melt-blown non-woven material treated by this process has a negligible drop in filtration efficiency after a high-temperature and high-humidity aging test, thus increasing the service life of the protective mask and also extending the shelf life of the mask.

In one embodiment, the density of the melt-blown non-woven material of inner layer 104 is higher than the density of outer layer 102 due to its structure, therefore, after adding electret static electricity, the melt-blown material can filter smaller particles. In one embodiment, the melt-blown non-woven material is configured to filter small particles PM 2.5 or 0.25 microns in width or less.

With two layers of electrostatically charged fabric (outer layer 102 and inner layer 104), the disposable protective face masks of the present invention are able to resolve the conflict between high filtration efficiency and low resistance traditional face masks generally face. The combination of these two layers of filtration allows the protective masks to achieve efficient high filtration without increasing thickness, weight, or breathing resistance.

In one embodiment, outer layer 102, inner layer 104, padding layer 106, and combinations thereof are flexible and have sufficient shear strength so that they generally retain their structure under expected use conditions.

In one embodiment, the protective masks of the present invention are disposable. In one embodiment, the protective masks of the present invention may be used for at least 8 hours of protection.

After experimentation, testing, and verification, the breathing resistance of the protective masks of the present invention is effectively reduced with this new process. In one embodiment, the protective masks can retain a low differential pressure of less than 4.0 mmH₂O/cm², while at the same time meeting the N95 mask standard. In some embodiments, the ventilation resistance of the protective masks is between about 75 Pa-85 Pa less than that of standard masks. This process solves the problem of maintaining high filtration efficiency and low resistance in the mask industry.

In one embodiment, the protective masks further comprises a nose clip positioned on the body configured to bend over and conform to the shape of the wearer's nose to create a seal within the nasal area. In one embodiment, the nose clip may be made of a material including but not limited to a pliable soft metal or plastic. In one embodiment, the nose clip may be made from aluminum. In one embodiment, the nose clip may be made from silicone. In one embodiment, the nose clip can be shaped to fit different wearers.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples, therefore, specifically point out the preferred embodiments of the present invention, and are not to be construed as limiting in any way the remainder of the disclosure.

### Example 1: Method of Measuring the Service Life of Disposable Masks

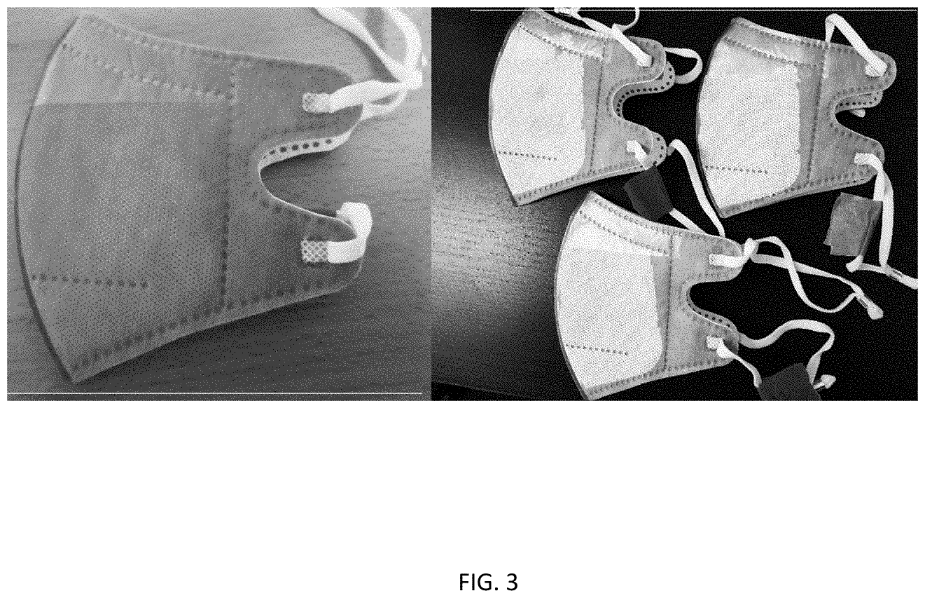

Supply NaCl particles at a rate of 0.1 mg/min, and deliver air containing NaCl particles to masks without exhalation valves at a flow rate of 40 liters/min (FIG. 3). Service life is measured by the time it takes for inhalation resistance in a mask to reach 120 Pa (JIS T 8151:2018 Japanese Industrial Standard). Under these conditions, the masks of the present invention maintained inhalation resistances under 120 Pa for at least 8 hours.

### Example 2: Increase Efficiency Rate and Longer Filtration Hours, while Reducing Resistance to Allow Face Masks to Stay on During Work Hours

The filtration efficiency of the melt-blown non-woven material itself is about 70%. Existing masks increase filtration efficiency by increasing material weight and thickness, thus greatly increasing breathing resistance. The present invention adds electret masterbatch to the melt-blown non-woven material to improve the filtration efficiency by using the adsorption principle of the electrostatic charge effect. In order to increase the service life of masks, after repeated trials, verifications, and tests, the use of static masterbatch electret to create electrostatic charge can effectively improve the filtration efficiency of the fabric without increasing filtration resistance. Because the masterbatch electret's static electricity retention is more than 3 times that of the electric electret, the filtration efficiency barely decreases with after exposure to high temperature and high humidity. The outer layer of non-woven fabric is also treated with the same electret treatment process, so that the primary filtration is carried out to remove large particles above PM 3.0, and then the electret melt-blown is used to remove the small particles less than PM 2.5. When exhaling, the larger particles on the surface of the exterior of the mask falls off with the exhaled air, thus prevents resistance build-up. This protects the melt-blown non-woven material and greatly increases the filtration efficiency of the mask, as well as increasing its time of usage, without increasing the mask's resistance.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A protective face mask comprising:
a body having a two-layer filtration system comprising an outer layer and an inner layer, each layer comprising an electret masterbatch material having an electrostatic charge; and
an attachment means, wherein the attachment means are configured to hold the body over a mouth and nose of a wearer.

2. The protective face mask of claim 1, wherein the outer layer comprises a filtration efficiency of between about 50% and 70% and a ventilation resistance of between about 20-40 Pa.

3. The protective face mask of claim 1, wherein the inner layer comprises a filtration efficiency of between about 80% and 90% and a ventilation resistance of between about 35-55 Pa.

4. The protective face mask of claim 1, wherein the outer layer is configured to filter particles that are above PM 3.0 in size.

5. The protective face mask of claim 1, wherein the inner layer is configured to filter particles less than PM 2.5 in size.

6. The protective face mask of claim 1, wherein the two-layer filtration system has a combined filtration efficiency of at least 96%.

7. The protective face mask of claim 1, wherein the outer layer and the inner layer each comprises a filtration efficiency and a ventilation resistance that are each adjustable such that different permutations and combinations are produced targeting different industries and users.

8. The protective face mask of claim 1, wherein the electret masterbatch comprises a cooled water process configured to achieve a high-volume electrostatic charge.

9. The protective face mask of claim 1, wherein the electret masterbatch is a polypropylene masterbatch.

10. The protective face mask of claim 1, wherein the outer layer comprises between about 60% and 85% coarse fibers and between about 15% and 40% fine fibers.

11. The protective face mask of claim 1, wherein the inner layer comprises about 30% coarse fibers and about 70% fine fibers.

12. The protective face mask of claim 1, wherein a density of the inner layer is greater than a density of the outer layer.

13. The protective face mask of claim 1, wherein the face mask is configured to retain a low differential pressure of less than 4.0 mmH₂O/cm².

14. The protective face mask of claim 1, wherein the attachment means are in the form of ear loops, configured to loop behind the wearer's ears.

15. The protective face mask of claim 1, wherein the attachment means are in the form of a head strap, configured to wrap around the wearer's head.

16. The protective face mask of claim 1, wherein the face mask further comprises a nose clip positioned on the body and is configured to bend the protective mask over the wearer's nose to create a seal within a nasal area.

17. A method of electrostatic treatment using cooled water in a non-woven material, comprising the steps of:
providing a base non-woven material;
spunlacing the non-woven material, such that an electrostatic charge is generated on the non-woven material through friction between cooled water and the non-woven material; and
drying the non-woven material.

18. The method of claim 17, wherein the drying step is performed using a blower vacuum.

19. The method of claim 17, wherein the drying step is performed using an oven.

20. The method of claim 19, wherein the oven is set at a temperature between about 60° C. and 80° C.
